(19) United States
(12) Patent Application Publication
(10) Pub. No.: US 2001/0021216 A1
(43) Pub. Date: Sep. 13, 2001

(54) Configuration and method for measuring a temperature of a semiconductor disk

(76) Inventor: Olaf Storbeck, Dresden (DE)

Correspondence Address: LERNER AND GREENBERG, P.A., Post Office Box 2480, Hollywood, FL, 33022-2480, US

(21) Appl. No.: 09/799,864

(22) Filed: Mar. 2, 2001

(30) Foreign Application Priority Data
Mar. 2, 2000 (EP) EP 00 104 352.0

(51) Int. Cl. G01J 5/02; G01K 1/14; G01K 13/00

(52) U.S. Cl. 374/121; 374/141

(57) ABSTRACT

A configuration for measuring a temperature of a semiconductor disk is described and contains a supporting device for holding the disk, and at least two digital camera monitoring systems for locating edges of the disk. A data processing unit is connected to the digital camera monitoring systems for monitoring disk edge movement. The digital camera monitoring systems are placed in the supporting device in different positions. The digital camera monitoring systems face toward the disk. The supporting device further has transparent windows placed in the surface of the supporting device that are oriented towards the disk. With this configuration, disk dimensional growth due to disk heating during a manufacturing process can be measured in order to derive a disk temperature. Thus, a precise disk temperature measurement with real time data acquisition can be performed.

### BACKGROUND OF THE INVENTION

1. Field of the Invention

The present invention relates to a configuration for measuring a temperature of a semiconductor disk and contains a supporting device for holding the disk, and to a method for measuring the temperature of the semiconductor disk.

In the technical field of manufacturing of semiconductor devices the semiconductor devices usually are formed like disks containing a semiconductive material like silicon. For example, the disks are formed as wafers for producing semiconductor chips or as flat panels on the basis of silicon glass for producing display systems. In the manufacturing process, generally the disks are supported by a supporting device such as a wafer chuck for holding the disks.

In the process of manufacturing of e.g. a semiconductor wafer, it is common and necessary to apply various process steps to the wafer. With certain process techniques the wafer gets heated e.g. in processes where ion bombardment or plasma etching is applied. For example, during plasma etching the energy of the plasma is transferred partly to the wafer causing wafer heating. In certain processes, the wafer heating caused during a process is unintended. In order to remove unintended heat from the wafer, usually the supporting device or respective wafer chuck is cooled e.g. by water.

In particular for preventing damages or process failures, the water temperature is a process parameter which needs to be monitored and/or controlled during a manufacturing process. In a relative low temperature range of 50° C. to 500° C. common measurement techniques are not quite suitable. Current technology using e.g. thermo-elements typically has a temperature lag between the wafer temperature and the measurement point of the cooling water return loop. Technologies using detectors for detecting radiation emitted by the heated wafer have to deal with the problem that due to relative low temperatures there is only a relative low amount of radiation to be detected. Therefore, the existing technologies usually contain a relative small accuracy.

### SUMMARY OF THE INVENTION

It is accordingly an object of the invention to provide a configuration and a method for measuring a temperature of a semiconductor disk which overcome the above-mentioned disadvantages of the prior art devices and methods of this general type, the configuration being suitable for precise measuring of relative low disk temperatures during a manufacturing process.

With the foregoing and other objects in view there is provided, in accordance with the invention, a configuration for measuring a temperature of a semiconductor disk. The configuration contains a supporting device for holding the semiconductor disk. The supporting device has a surface and transparent windows disposed in the surface of the supporting device oriented towards the semiconductor disk. At least two digital camera monitoring systems for locating edges of the semiconductor disk are provided. The digital camera monitoring systems are disposed in different positions in the supporting device. The digital camera monitoring systems face toward the semiconductor disk so that the edges of the semiconductor disk can be located from a rear side by the digital camera monitoring systems. A data processing unit is connected to the digital camera monitoring systems for monitoring disk edge movements.

The configuration is applicable to various disks containing a semiconductor material like silicon, such as wafers for manufacturing semiconductor chips or flat panels on the basis of silicon glass for producing display systems. The provided configuration is preferably applicable to wafers having at least a 300 millimeter diameter. In the manufacturing process, generally the disks are supported or clamped by the supporting or clamping device such as a wafer chuck for holding the disks.

The configuration is suitable for temperature measurement of the disk supported or clamped by e.g. an electrostatic, physical clamping or vacuum clamping device for holding the disk. With the digital camera monitoring systems and the connected data processing unit, disk dimensional growth due to disk heating can be observed or monitored. Therefore, the edges of the disk are located. Thereafter, a present disk edge movement is monitored and data of the digital camera monitoring systems that contains information about disk edge movement is processed. With this information, after appropriate calibration processing, the disk temperature can be derived. There are at least two digital camera monitoring systems placed in different, preferably opposite, positions in the supporting device to compensate e.g. for an offset of disk dimensions or disk placement.

If the absolute loading temperature of the disk is obtained before starting the manufacturing process, the absolute temperature during the manufacturing process can be calculated and monitored by processing the absolute loading temperature together with the data about disk edge movement.

With the configuration, real time data acquisition is possible. Compared with measurement techniques using thermo-elements, disk dimensional growth due to disk heating usually has relative low retardation times in relation to the actual temperature. Also, precise temperature measurement of relatively low temperatures in the range of about 50° C. to 500° C. is possible.

For protection of the complete digital camera monitoring systems the supporting device has transparent windows of a material suitable for the applied environmental conditions e.g. sapphire or quartz.

Advantageously, charged coupled device (CCD) camera technology is used for the digital camera monitoring systems. With a monitoring device of a CCD type containing a CCD-chip and accompanying electronics, there is achieved sufficient resolution at relatively low costs with using standard CCD elements.

Preferably, each of the digital camera monitoring systems contains an optical lens system for enlarging the projections. For example, an enlargement of about 10 to 50 times in an application using wafers of at least 300 mm in diameter will lead to sufficient resolution for measuring a 1 K temperature rise or fall with standard CCD elements.

According to an embodiment of the invention, the supporting device is temperature-controlled by a control device containing a heat carrier performing a heat transfer from or to the disk. As a heat carrier, water is preferably used for cooling the supporting device such as a wafer chuck. With the accurate temperature measured and monitored by the configuration, the control device, e.g. a cooling circuit with appropriate regulating valves and a device for controlling the regulating valves, can be controlled manually or automatically. So, an appropriate temperature of the disk can be adjusted.

In a further embodiment, the data processing unit is connected to the control device performing a closed-loop temperature control system. With this configuration, an automatic temperature control system is performed for precisely controlling e.g. the so-called wafer bulk temperature.

To improve the measuring functionality of the configuration, the configuration contains a light emitting source for illuminating a surface of the disk opposite to the digital camera monitoring systems. For a proper measurement result, there is necessary a sufficient amount of light emitted towards the camera monitoring systems next to the disk edges. Especially, the light emitting source is necessary during processes in which an insufficient amount of light is emitted e.g. from the processing gases.

With the foregoing and other objects in view there is provided, in accordance with the invention, a method for measuring a temperature of a semiconductor disk. The method includes the steps of providing a configuration or measuring device as described above. The measuring device is calibrated to compensate for an offset of disk dimensions and disk placement. The edges of the semiconductor disk are located by the digital camera monitoring systems and a present disk edge movement is monitored. Data from the digital camera monitoring systems containing information about the disk edge movement are produced and the data is processed to derive disk temperature information.

Other features which are considered as characteristic for the invention are set forth in the appended claims.

Although the invention is illustrated and described herein as embodied in a configuration and a method for measuring a temperature of a semiconductor disk, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic illustration of an embodiment of a measuring configuration according to the invention; and

FIG. 2 is an illustration of a more detailed view of the embodiment.

### DESCRIPTION OF THE PREFERRED EMBODIMENTS

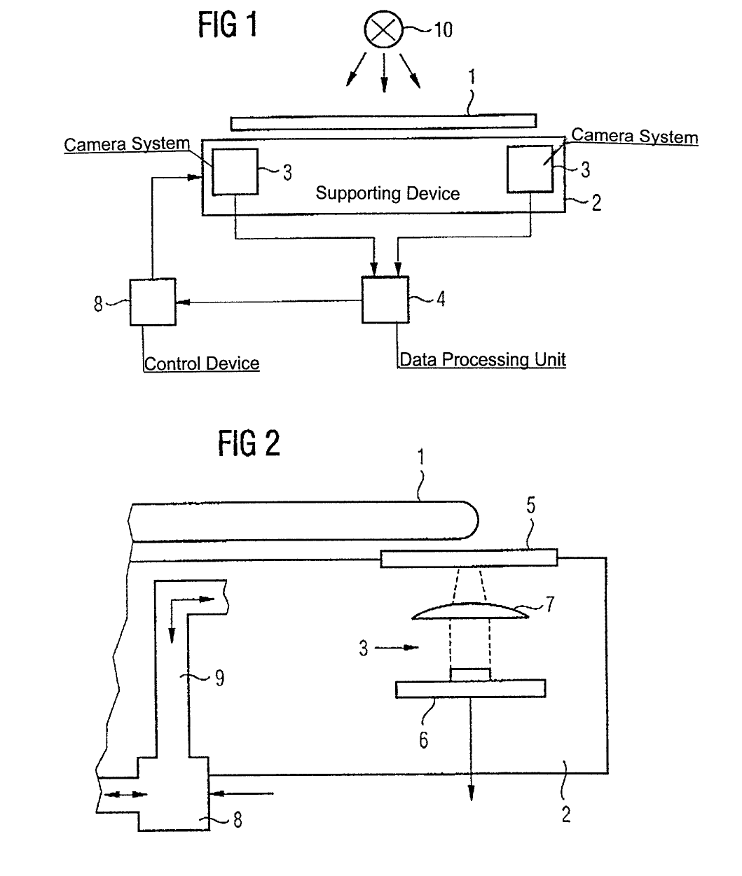

In all the figures of the drawing, sub-features and integral parts that correspond to one another bear the same reference symbol in each case. Referring now to the figures of the drawing in detail and first, particularly, to FIG. 1 thereof, there is shown a configuration for measuring a temperature of a semiconductor disk such as a wafer 1, which is preferably circular shaped. The configuration has a supporting or clamping device 2 formed as a wafer chuck. The configuration further contains two digital camera monitoring systems 3 for locating edges of the wafer 1 and a data processing unit 4 connected to the digital camera monitoring systems 3 for monitoring a disk edge movement. The digital camera monitoring systems 3 are placed in the wafer chuck 2 and in different positions of the wafer chuck 2, here in opposite or diametrical positions, respectively. The digital camera monitoring systems 3 are facing towards the wafer 1.

FIG. 2 shows a more detailed view of the configuration illustrated in FIG. 1. For each of the digital camera monitoring systems 3, the wafer chuck 2 has a transparent window 5 being placed in a surface of the chuck 2 which is turned towards the wafer 1, so that the edges of the wafer 1 can be located by the camera monitoring systems 3. Each of the windows 5 is formed of a material suitable for the applied environmental conditions. Therefore, the windows 5 are formed of e.g. sapphire (Al₂O₃) or quartz (SiO₂). Each of the digital camera monitoring systems 3 contains a monitoring device 6 of a charged coupled device (CCD) type. For example, the monitoring device 6 is formed of a CCD-chip and the accompanying electronics. Further, each of the digital camera monitoring systems 3 contains an optical lens system 7 for enlarging the projection of the edges of the wafer 1.

In the embodiment shown in FIG. 2, the wafer chuck 2 is temperature-controlled by a control device 8 that contains a heat carrier 9. By moving the heat carrier 9 along the surface of the wafer 1, there is performed a heat exchange from or to the wafer 1. The control device 8 is formed as a part of a cooling circuit with appropriate regulating valves and a device for controlling the regulating valves. The control device 8 is controlled automatically. Thus, as shown in FIG. 1, the data processing unit 4 is connected to the control device 8 performing a closed-loop temperature control system.

The temperature of the wafer 1, in particular the temperature of the bulk of the wafer 1, can be measured by using thermal dimensional growth of the wafer 1. In the case of heating the wafer 1, the thermal expansion of the wafer 1 can be used to derive a temperature increase. Usually, for a wafer formed of silicon, the linear thermal expansion coefficient between the temperatures of 25° C. and 400° C. is about α=2.5×10⁻⁶ K⁻¹ up to α=4.0×10⁻⁶ K⁻¹. Therefore, with a wafer diameter of 300 mm there is an average expansion of Δl=1 μm/K. Eventually deposited material layers on the wafer 1 bulk do not have considerable effect concerning the dimensional growth of the wafer 1, because the thickness of the deposited layers is very small compared to the thickness of the wafer 1.

As mentioned above, the incorporated optical lens systems 7 have the effect of enlarging the projection. With the abovementioned example of numbers, an enlargement of about 10 to 50 times will lead to a resolution of 10 to 50 μm for measuring 1 K. With this resolution standard CCD elements are applicable. If an accuracy of 10 K is enough for a proper measurement, a lower resolution of 100 to 500 μm is sufficient. In this content, a high resolution results in that the CCD elements can achieve a high selection of pixels. So, with a lower resolution, the diameters of the digital monitoring pixels within the CCD elements can be increased.

The thermal expansion of the wafer 1 due to wafer heating shifts the pictures of the edges of the wafer 1 across the CCD elements. This shift could be used to determine the temperature shift of the wafer 1. For temperature measurement, the edges of the wafer 1 are located. Thereby, a present wafer edge movement is monitored by the digital camera monitoring systems 3. The data provided by the digital camera monitoring systems 3 containing information about wafer edge movement is processed in the data processing unit 4. With this information, after appropriate calibration processing, a wafer temperature can be derived. For calibration, there are necessary at least two CCD elements to compensate for an offset of the wafer diameter or wafer placement.

If the absolute loading temperature of the wafer 1 is obtained before starting the manufacturing process, the absolute wafer temperature during the process can be calculated and monitored.

For improving the contrast of the wafer edges projected to the CCD elements, the configuration according to FIG. 1 contains a light emitting source 10 for illuminating the surface of the wafer 1 opposite to the digital camera monitoring system 3.

I claim:

1. A configuration for measuring a temperature of a semiconductor disk, the configuration comprising:
a supporting device for holding the semiconductor disk, said supporting device having a surface and transparent windows disposed in said surface of said supporting device and oriented towards the semiconductor disk;
at least two digital camera monitoring systems for locating edges of the semiconductor disk, said digital camera monitoring systems disposed in different positions in said supporting device, said digital camera monitoring systems face toward the semiconductor disk so that the edges of the semiconductor disk can be located from a rear side by said digital camera monitoring systems; and
a data processing unit connected to said digital camera monitoring systems for monitoring disk edge movements.

2. The configuration according to claim 1, wherein each of said digital camera monitoring systems contain a monitoring device of a charged coupled device type.

3. The configuration according to claim 1, wherein each of said digital camera monitoring systems contain an optical lens system for enlarging a projection.

4. The configuration according to claim 1, including a control device having a heat carrier disposed in said supporting device for performing a heat transfer to and from the semiconductor disk, said supporting device being temperature-controlled by said control device.

5. The configuration according to claim 4, wherein said data processing unit is connected to said control device resulting in a closed-loop temperature control system.

6. The configuration according to claim 1, wherein each of said transparent windows is formed of a material selected from the group consisting of quartz and sapphire.

7. The configuration according to claim 1, including a light emitting source for illuminating a surface of the semiconductor disk opposite said digital camera monitoring systems.

8. The configuration according to claim 4, wherein said control device is configured for maintaining the semiconductor disk in a temperature range of 50° C. to 500° C.

9. The configuration according to claim 1, wherein the semiconductor disk is circular shaped and said digital camera monitoring systems are placed in diametrical positions for locating the edges the semiconductor disk.

10. The configuration according to claim 9, wherein the semiconductor disk is a wafer having a diameter of least 300 millimeters and said supporting device is configured for handling the semiconductor disk.

11. A method for measuring a temperature of a semiconductor disk, which comprises the steps of:
providing a measuring device comprising:
a supporting device for holding the semiconductor disk, the supporting device having a surface and transparent windows disposed in the surface of the supporting device and oriented toward the semiconductor disk;
at least two digital camera monitoring systems for locating edges of the semiconductor disk, the digital camera monitoring systems disposed in different positions in the supporting device, the digital camera monitoring systems face toward the semiconductor disk so that the edges of the semiconductor disk can be located from a rear side by the digital camera monitoring systems; and
a data processing unit connected to the digital camera monitoring systems for monitoring disk edge movements;
calibrating the measuring device to compensate for an offset of disk dimensions and disk placement;
locating the edges of the semiconductor disk with the digital camera monitoring systems;
monitoring a present disk edge movement;
producing data from the digital camera monitoring systems containing information about the disk edge movement; and
processing the data to derive disk temperature information.

12. The method according to claim 11, which comprises:
obtaining an absolute loading temperature of the semiconductor disk before starting a manufacturing process; and
processing the data and the absolute loading temperature to derive an absolute disk temperature.
